(19) United States
(12) Patent Application Publication
(10) Pub. No.: US 2026/0239234 A1
(43) Pub. Date: Aug. 13, 2026

(54) POWER HEADROOM TRIGGERING AND REPORTING FOR UPLINK POLARIZATION-BASED OPERATION

(71) Applicant: InterDigital Patent Holdings, Inc., Wilmington, DE (US)

(72) Inventors: Virgil Comsa, Montreal (CA); Afshin Haghighat, Ile-Bizard (CA); Loic Canonne-Velasquez, Dorval (CA); Jonghyun Park, Syosset, NY (US)

(73) Assignee: InterDigital Patent Holdings, Inc., Wilmington, DE (US)

(21) Appl. No.: 19/470,978

(22) PCT Filed: Apr. 4, 2024
(86) PCT No.: PCT/US2024/022921

§ 371 Date: Sep. 30, 2025

Related U.S. Application Data
(60) Provisional application No. 63/457,044, filed on Apr. 4, 2023.

(51) Int. Cl. H04W 52/36; H04B 17/318

(52) U.S. Cl. CPC H04W 52/365; H04B 17/328

(57) ABSTRACT

A WTRU and a method for power headroom triggering and reporting for uplink polarization-based operation are provided. A wireless transmit/receive unit (WTRU) sends a power capability. The power capability is associated with one or more antenna ports or antenna port groups. The WTRU determines that a condition is satisfied. The condition includes one or more of the power capability of the WTRU changing or a serving panel of the WTRU changing. The WTRU sends a power headroom report (PHR) based the condition being satisfied. The PHR indicates a maximum power associated with a first polarization type and a maximum power associated with a second polarization type.

### CROSS-REFERENCE TO RELATED APPLICATIONS

This application claims the benefit of U.S. Provisional Application No. 63/457,044, filed Apr. 4, 2023, the contents of which is incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are configured for power headroom triggering and reporting for uplink polarization-based operation. A wireless transmit/receive unit (WTRU) may send a power capability. The power capability may be associated with one or more antenna ports or antenna port groups. The WTRU may determine that a condition is satisfied. The condition may include one or more of the power capability of the WTRU changing or a serving panel of the WTRU changing. The WTRU may send a power headroom report (PHR) based the condition being satisfied. The PHR may indicate a maximum power associated with a first polarization type and a maximum power associated with a second polarization type.

The first polarization type may include a first orientation polarization type, and the second polarization type may include a second orientation polarization type. The condition may include one or more of the following: the WTRU is configured for multi-Transmission Reception Point (mTRP) operation, a difference between a measured horizontal Reference Signal Received Power (H-RSRP) and a measured vertical Reference Signal Received Power (V-RSRP) exceeds a threshold, an uplink (UL) polarization the WTRU is using for a transmission reference point (TRP) changes, or a maximum power for an active polarization type changes by more than a threshold.

The PHR may include one or more of the following: a power capability of the WTRU or an indication of an active UL polarization. The indication of the active UL polarization may be associated with a TRP. The indication may identify the TRP associated with the UL polarization.

Systems, methods, and instrumentalities are configured for Power Headroom Report (PHR) triggering and reporting for Uplink (UL) polarization-based operation. A wireless transmit/receive unit (WTRU) may send a power capability associated with one or more antenna ports or antenna port groups.

The WTRU may sending a power headroom report (PHR) when conditions are met. The conditions may include the WTRU being configured for multi-Transmission Reception Point (mTRP) operation, changes in the WTRU's power capability or serving panel, a significant difference between measured horizontal and vertical Reference Signal Received Power (H-RSRP and V-RSRP), changes in the WTRU's UL polarization for a TRP, and/or a substantial change in maximum power for the active polarization type. The PHR may include information on horizontal polarization maximum power (Pcmax-Hz), vertical polarization maximum power (Pcmax-Vt), and/or an indication of the active UL polarization.

The WTRU may send the power capability in response to a network request. The threshold for the difference between H-RSRP and V-RSRP may be received from a network or configured by the WTRU.

Measurement Reference Signals (RS) used for calculating H-RSRP and V-RSRP may be a Synchronization Signal Block (SSB), a Channel State Information Reference Signal (CSI-RS), or a pathloss RS. Additionally, the order of active UL polarization indications in the PHR may determine or indicate the associated TRP.

### BRIEF DESCRIPTION OF THE DRAWINGS

Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment; and

FIG. 2 illustrates Multi RX reception with two panels (or sub-arrays) with two different DL polarization.

### DETAILED DESCRIPTION

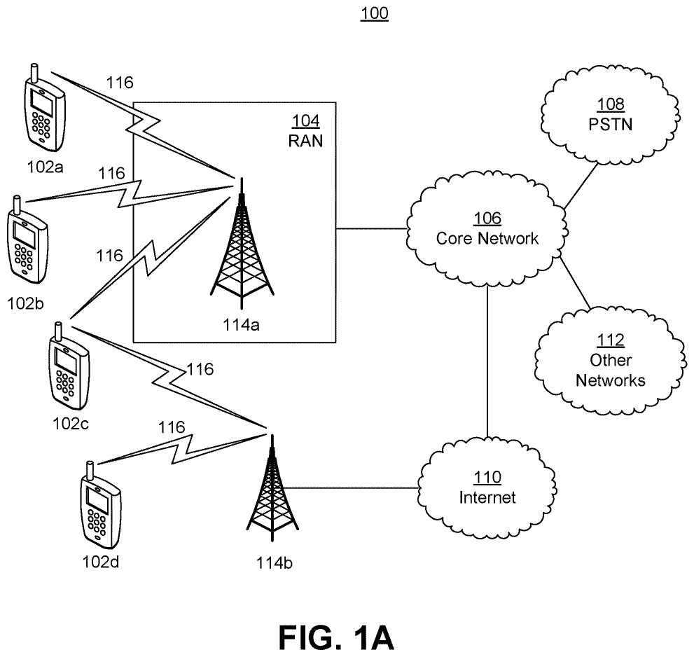

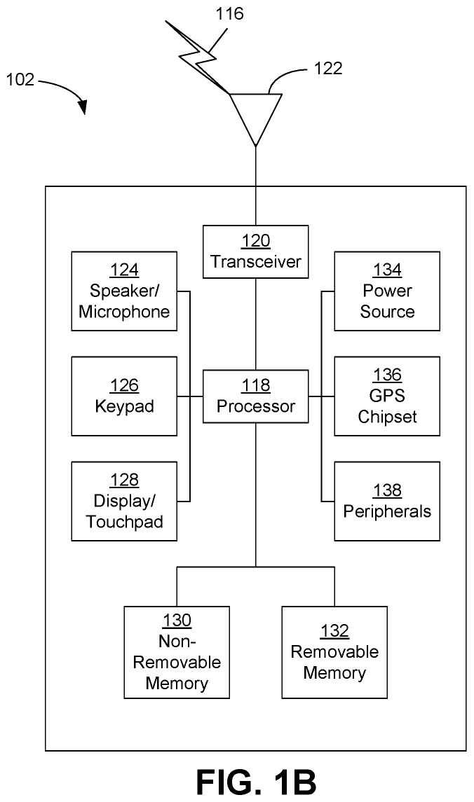

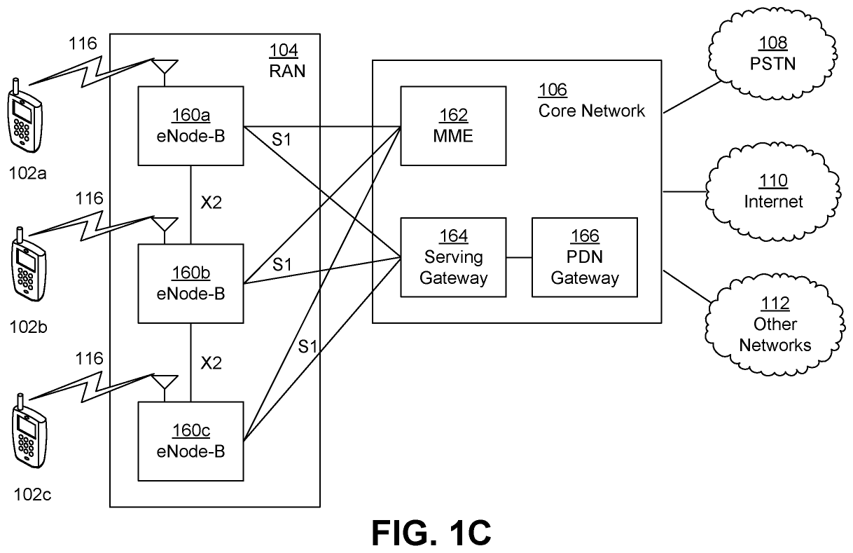

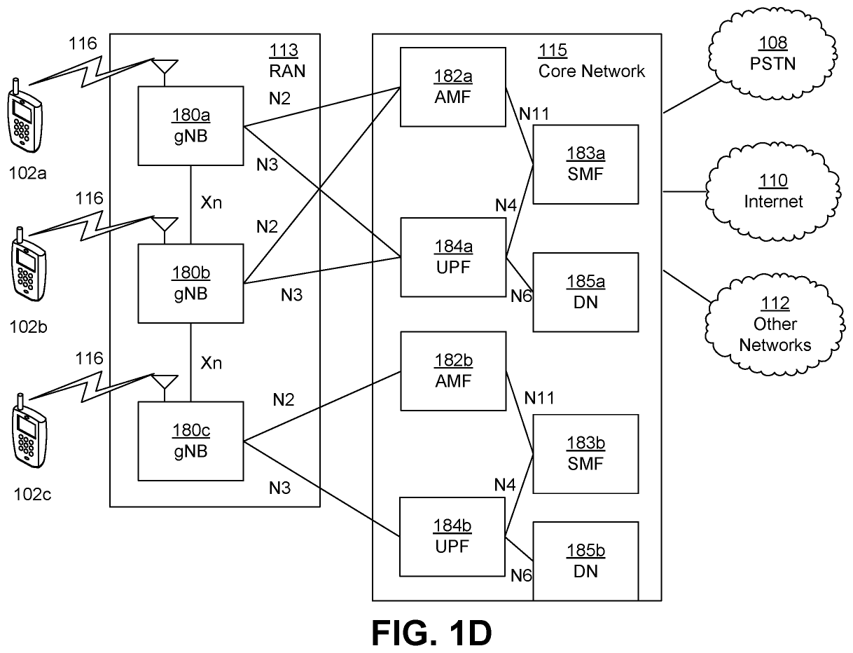

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Features described herein may be associated with a multi-panel WTRU. An MPUE or a MPWTRU may be a WTRU that is equipped with a multiple panels antenna and has the capability of receiving/transmitting multiple beams with different angles of arrival (AoA). Panels may be a structural part of a WTRU antenna system that has one or more of the following properties. It may be a unit of an antenna group that controls a beam. Within a panel, a beam may be selected and used for DL reception. Across panels (e.g., difference panels), multiple beams may be selected (e.g., one per panel) and may be used for DL reception. A physical panel with dual polarization may be seen as two panels (e.g., one per polarization.

A beam may mean a spatial filter associated with reception (e.g., in a DL context). A beam may be associated with a TCI state describing a spatial filter associated with the reception of a beam.

As described herein, the polarization for a panel may be related to a cross-polarization capability of the antenna elements in the antenna system structure that allow for quasi-orthogonality of transmission/reception.

Features described herein may be associated with a polarization component (e.g., type-1 and type-2). A polarization component may represent the transmitted signal on one of the available polarizations of the antenna port antenna group or panel. In examples, a cross-polarized antenna may have a horizontal (Hz) and a vertical (Vt) component where the Hz and Vt components (e.g., type-1 and type-2, respectively) make use of the assigned Hz antenna elements and Vt elements, respectively.

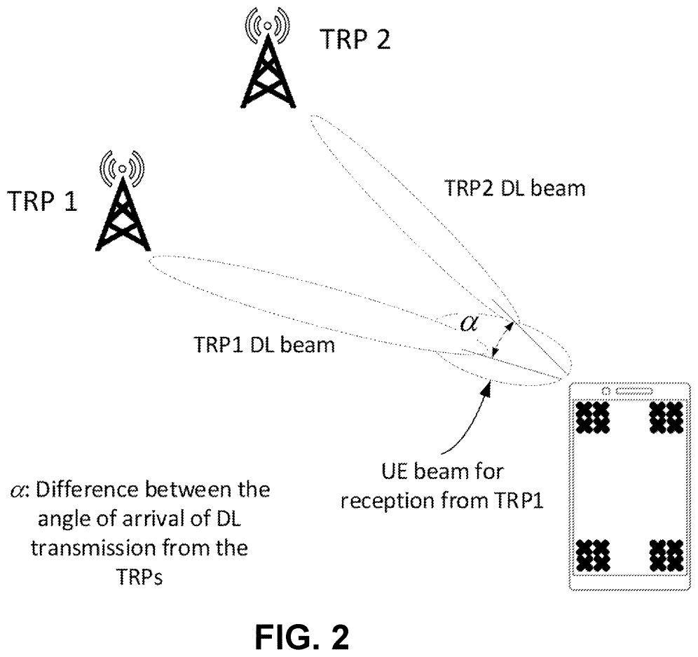

As described herein, the angle of arrival (AoA) a may be a relative angle between two received beams, as shown in FIG. 2. As described herein, the angle of departure (AoD) a may be a relative angle between two transmitted beams as shown in FIG. 2.

A WTRU may support multi-TRP reception in either sDCI or mDCI modes. In the mDCI mode, there may be simultaneous receptions from two non-collocated TRPs that are in inter-cell or intra-cell configurations. The configurations may (e.g., completely) overlap in frequency domain, using the same channel and channel bandwidth. Multi-RX may be referred to as the reception capability of a WTRU in a downlink multi-TRP configuration. Multi-RX WTRU testing methodologies may reveal that a muti-panel UE or a multi panel WTRU (MPWTRU) experiences inter-TRP interference. The terms MPUE and MPWTRU may be used interchangeably herein.

FIG. 2 illustrates Multi RX reception with two panels (or sub-arrays) with two different DL polarization. As shown in FIG. 2, the inter-TRP interference may be due to the fact that there is spillage of signal from a second TRP to a first TRP when a WTRU receiving beam is intended for reception from the first TRP. This may be detrimental to the WTRU's performance, for example, as the difference between the angle of arrivals from the two TRPs decreases. To mitigate inter-TRP interference, polarizations (e.g., difference polarizations) may be considered at a TRP. Techniques may detect, measure, and/or employ schemes to reduce inter-TRP interference at the WTRU side.

The current WTRU CSI measurements and network CSI-RS configurations may not be adequate.

For example, the current WTRU CSI measurements may not consider polarization dimension at the WTRU side. A dimension for the CSI-RS transmission and measurement (e.g., polarization) may be provided to mitigate the MPUE inter-TRP interference.

The UL transmissions may be associated with a polarization operation based on multi-TRP being configured and UL overlapping transmissions in time and/or frequency occuring.

As MIMO capable systems support polarized antennas (e.g., cross-polarized), to enable/improve a Multi RX reception for MPUE, mitigation of the inter-polarization interference between receptions, polarizations at the transmission side (e.g., at a TRP) may be used. The WTRU may measure the inter-polarization interference and report it back to the network. To address the inter-polarization interference, the polarization of the RS pilots for the evaluation may be considered as a configuration, measurement dimension, and reporting.

Techniques for measuring the interference at the WTRU side may be limited to measurements on zero power (ZP) CSI resources that are known as CSI-IM resources. Configuration of ZP CSI-IM resources may provide an opportunity to measure the background system-wide interference. This technique (or any other RS related measurements) may not allow for inter-polarization interference measurements that would consider polarization dimension of the transmission/reception. The gNB may have cross-polarized elements in its antennas.

In a multi-TRP deployment, inter-polarization interference may be a performance-limiting factor. The multi-RX reception may be greatly improved by cross-polarization reception per panel for an MPUE. In some cases, support may not be provided for polarization-based CSI configuration, measurements, and reporting.

For the uplink MIMO transmission in a multi-TRP scenario, the polarization-based operation may be supported (e.g., for the simultaneously transmissions for the multi-panel WTRUs (STxMP)). In an mDCI case, where the UL grants may come independently overlapping or non-overlapping RB allocations may occur. When the RB allocations overlap due to complexity of MPR (Maximum Power Reduction) application rules, and the WTRU implementation is challenged for antenna panels, the polarization-based operation may reduce the complexity and a number of parameters to account for to avoid self-interference (e.g., when two timing advance (TA) situations are to be accounted for UL power imbalance, transmission polarization selection).

For operations affected by the polarization-based uplink simultaneous transmissions in a multi-TRP scenario, the PHR (Power Headroom Report) may take into consideration power allocation that may be polarization based and related to a WTRU's power per/panel/polarization capabilities. Systems and methods associated with the polarization-based operation may be provided.

In examples addressing inter-polarization interference, an MPUE may be referred to as the target device, and a (e.g., the same) technique and discussion may be applied to a single panel WTRU with simultaneous multiple receive beam capability. A two TRP system may be used, and a technique (e.g., the same technique) may be applied for a system with more than two TRPs.

Features described herein may be associated with polarization-based operation for cross-polarization interference mitigation, including CSI-RS measurements, UL operations and PHR operation.

UL polarization-based operation may include PHR triggering and reporting. A WTRU may perform one or more of the following. A WTRU may declare (e.g., indicate) its power capability (e.g., the WTRU may send the power capability), for example, as power sharing or non-power sharing. The power capability may be associated with one or more antenna ports or antenna port groups.

If one or more of the following events occur or conditions are satisfied (e.g., the WTRU may determine that a condition is satisfied, and the condition may include one or more of the power capability of the WTRU changing or a serving panel of the WTRU changing, as described herein), the WTRU may trigger and/or send a power headroom report (PHR). The one or more events or conditions may include one or more of the following. The WTRU may be configured or reconfigured for multi-TRP (mTRP) operation (e.g., UL mTRP operation). The WTRU's power capability may change (e.g., the WTRU's power capability may change from power sharing to non-power sharing or from non-power sharing to power sharing). The WTRU's serving panel may change. The WTRU may determine that the difference between measured H-RSRP and measured V-RSRP exceeds a threshold (e.g., a received and/or configured threshold), for example, for at least an amount of time that may be configured. H-RSRP may be a polarization-based RSRP measurement of a first measurement RS using horizontal polarization. V-RSRP may be a polarization-based RSRP measurement of a second measurement RS using vertical polarization. A measurement RS may be an SSB, a CSI-RS, or a pathloss RS, and the first and second measurement RSes may be the same or different measurement RSes. The UL polarization of the WTRU is using for a TRP changes. The Pcmax for the active polarization type changes (e.g., may change) by more than a threshold (e.g., Pcmax for the active polarization type may be received and/or configured).

The PHR may include at least one of the following: a power capability of the WTRU (e.g., its current or active power capability) which may be sharing or non-sharing; a maximum power associated with a first polarization type (e.g., a first orientation polarization type associated with a horizontal polarization Pcmax (Pcmax-Hz)); a maximum power associated with a second polarization type (e.g., a second orientation polarization type associated with a vertical polarization Pcmax (Pcmax-Vt)); and/or an indication of the active UL polarization (e.g., the active UL polarization may be horizontal or vertical polarization). An indication (e.g., the indication of the active UL polarization) in a PHR may be provided per TRP. A TRP indication (e.g., a per TRP indication) may be provided to identify the TRP associated with the UL polarization (e.g., an active UL polarization indication). The order of the entries of the active UL polarization indications in the PHR may determine or indicate the associated TRP.

The Multi-Panel WTRU, operating into a multi-TRP in inter-cell or intra-cell configuration (with two TRPs) may maintain two power control loops. The WTRU may measure the RSRP and maintain pathloss estimations for two beams that have their own active TCI state that describes the QCL properties of the linked RS for downlink and uplink. When the polarization-based operation is configured and enabled by gNB, the power control, pathloss measurements, and WTRU power capabilities used at a certain moment in time may be known by a gNB scheduler for an optimized scheduling process in terms of power, frequency, and time allocation.

Power Headroom Report (PHR) may be reported per cell or beam. This report may include the Pcmax (Configured Maximum Power) evaluated for the UL grant that includes the PHR MAC CE, the P-MPR (if the MPE on FR2 report is configured), and the PHR. The PHR may be computed against the Pcmax and the allocated power for UL grant. The P-MPR may be the power management reduction that is applied based on the MPE (Maximum Permitted Exposure in FR2) or SAR limit (in FR1) being exceeded for a certain amount of time.

The PHR MAC CE with multiple entries may have the following format for a serving cell n entry, as depicted in Table 1:

TABLE 1
PHR MAC CE

| | | |
|---|---|---|
| P | V | PH (Type X, Serving Cell n) |

| | |
|---|---|
| MPE or R | P_{CMAX, f, c} m |

In Table 1, P may be a bit that is set to “1” if the P-MPR for MPE is configured and applied and is higher than PMR_00 (e.g., the lowest value specified). V may be a bit that is related to the type of PHR (real of virtual) for the serving cell “n”. If PMP-R for MPE is reported, then this 2 bit field may accommodate 4 standard values, or otherwise be reserved (e.g., set to zero). PH may be a 6 bits value for a 64 range of quantized quantities in dB. Pcmax may be a 6 bits value for a 64 range of quantized quantities in dBm.

PHR triggering may be provided. PHR triggering conditions specified may be related to the phr-Tx-PowerFactorChange dB, which may be a threshold configured by the gNB at the RRC level. A change in the pathloss measurements that last for a certain amount of time, exceeding the configured phr-ProhibitTimer, may trigger a PHR, since the pathloss may be directly reflected in the power allocation. If the MPE/SAR sensors detect human body proximity for at least a certain amount of time and the P-MPR is above a certain threshold, it may trigger a PHR as well. The activation/de-activation of a cell in carrier aggregation mode may trigger a PHR.

A PHR may be triggered upon WTRU configuration or reconfiguration of the multi-TRP. A MPUE may have (e.g., different) power capabilities on (e.g., different) panels and panel combinations that may be used based on serving (e.g., multiple) UL beams simultaneously. The power capabilities may lead to different combinations of panel groups and antenna ports supporting simultaneous UL transmissions. Two categories may be considered around power sharing or non-sharing status of an antenna group/panel(s) that may serve the beams UL transmissions: In a UL Power sharing state, serving UL beam antenna ports allocated power may reach a WTRU PowerClass level in EIRP terms, and based on two beams being transmitted simultaneously, the total transmitted power may be capped (e.g., as EIRP or as a Total Radiated Power). PowerClass may be achieved for a polarization. In an UL non-sharing state, serving UL beam antenna ports allocated power may not reach the PowerClass level in EIRP terms (e.g., for example two panels may go up to 20 dBm while the PowerClass is 23 dBm), and there may be no restrictions for the total transmitted power. This may be valid for a polarization.

Upon (e.g., based on) configuration of a WTRU with a multi-TRP by the gNB, a PHR may be triggered. The PHR report may include the Pcmax and PHR per beam and an indication of the power sharing or non-sharing status, according to the serving panel configuration the WTRU uses for UL beams transmissions. Upon a multi-TRP re-configuration, meaning a change in active TCI, a serving or non-serving TRP, the WTRU may trigger a PHR including the Pcmax, the PHR per beam, and the power sharing status according to the serving panels configuration used for UL transmissions.

Upon (e.g., based on) a multi-TRP WTRU configuration enabling the polarization-based operation, the WTRU may trigger a PHR. The PHR may include polarization specific parameters related to the UL polarization-based transmissions. In examples, for a beam, the PHR may including at least one or a combination of the following parameters: the Pcmax per polarization, the related polarization based PHR, an indication of the active polarization, and/or a TRP index. A PHR may be triggered upon a change in WTRU power capabilities or UL serving panels. During the polarization-based operation, the WTRU may change serving panels based on DL measurements or due to power requirements. The WTRU on a UL serving beam may determine that the power requirement is reduced or increased. This decision may be based on a pathloss estimation against a TRP or both TRPs in the configuration. A change in power requirement may translate into a change in WTRU power capabilities. Upon a change in power capabilities, the WTRU may get into a power sharing or non-sharing status. The change may trigger a PHR, and the PHR may include at least one or a combination of the following parameters for at least one or more UL beams: the Pcmax per polarization, the related polarization based PHR, an indication of the active polarization, and/or a TRP index.

PHR triggering may occur based on the difference between measured Hz_RSRP and Vt_RSRP exceeding a threshold. When the polarization-based operation is active, the particularities of the performed measurements on both polarization components (Hz-horizontal or Vt-vertical) of the configured RS may lead to triggering conditions. The WTRU may maintain measurements for the Hz and Vt components of the configured or associated pathloss RS based on the polarization-based operation being configured by a gNB and active.

As the WTRU is continuously measuring and monitoring the Hz and Vt polarizations based RSRP for a TRP (e.g., Hz_RSRP and Vt_RSRP), the movement of the WTRU may lead to measurement changes between Hz and Vt for example based on the WTRU rotating. The Hz_RSRP and Vt_RSRP measurements may be performed against an RS that may be an SSB, a CSI-RS or a pathloss RS, while the Hz and Vt based RSRP measurements may be based on the same or different Rses. This may imply that one of Hz or Vt polarization may become better than the other, and the used polarization may change. When the WTRU determines that the difference between a measured Hz_RSRP and a measured Vt_RSRP exceed a threshold (e.g., a received and/or configured threshold) for at least an amount of time that may be configured, the WTRU may trigger a PHR.

A PHR may be triggered upon a change in WTRU UL active polarization(s). The WTRU configured in a multi-TRP configuration with polarization-based operation to enable polarization-based measurements that use multiple panels for both TRPs. Additionally, the gNB may ask for UL transmissions on specific polarization types that may be indicated along with a DCI UL grant.

The WTRU may use the polarizations for its uplink transmissions in its serving panels by optimizing the UL power per polarization and/or mitigating self-interference, as the polarization-based transmissions may be quasi-orthogonal at the WTRU RF frontend. This may occur based on overlapping transmissions happening and the RB allocations for the UL grants overlapping in frequency domain. When the WTRU determines that an active UL polarization in the UL for a beam or both beams use a change, the WTRU may trigger a PHR that may include at least one or a combination of the following parameters for at least one or a UL beam: the Pcmax per polarization, the related polarization based PHR, an indication of the active polarization, and/or a TRP index.

A PHR may be triggered upon a change of Pcmax for an active polarization exceeding a threshold. When the WTRU is configured for polarization-based operation or determines that the transmissions of an UL grant is in polarization-based operation, the Pcmax may be estimated for the intended polarization type 1 or 2. The Pcmax value may be estimated in the context of a simultaneous transmission for a multi-TRP scenario where the mDCI STxMP is configured. The UL grants may have overlapping RB allocations in frequency and time domain. The AoD of the simultaneous transmitted beams may create examples where power reductions may be required. As the self-interference between UL beam transmissions may imply higher MPR in certain situations, for which the gNB scheduler may not have full knowledge on the WTRU side, based on the estimated Pcmax change exceeding a configured or determined threshold, for a certain amount of time, the WTRU may trigger a PHR that may include at least one or a combination of the following parameters for at least one or a UL beam: the Pcmax per polarization, the related polarization based PHR, an indication of the active polarization, and/or a TRP index.

A PHR may be triggered for a change of a serving beam or a TCI activation/de-activation. When the at least one TCI state or group of TCI states are re-configured or activated/de-activated, or a change of at least of a beam due to a beam failure, for example, that may involve, for example, a change in a QCL type E related to the polarization and quasi colocation (QCL) of the configured or determined reference RS, the WTRU may change the serving panels, or power properties of the serving panels may change. When the TCI state(s) change possibly affecting serving antenna port(s) configuration, the WTRU may trigger a PHR that may include at least one or a combination of the following parameters for at least one or a UL beam: the Pcmax per polarization, the related polarization based PHR, an indication of the active polarization, a TRP index.

A PHR may be reported. If the multi-TRP is an inter-cell scenario, where the PCI for the cells is different, the PHR per serving cell concept may be maintained in terms of the order of the entries in the MAC CE for a serving cell number stating from the Pcell (pTRP) and following with the Scells as secondary TRPs. For an mDCI STxMP scenario, the WTRU may use a dual entry PHR MAC CE due to the simultaneous nature of the transmissions of the UL grants that may be independent code words with different RB allocations and MCS. A UL beam may have its own PHR.

If the multi-TRP example is an intra-cell where the TRPs have the same PCI, a rule may be to have the first entry as the pTRP, followed by the secondary TRPs in order. The PHR report multi-TRP inter-cell scenario may be transmitted to the TRPs due to the importance of it for a scheduler involved in the UL grant scheduling. The PHR report for an intra-cell case may be sentjust to the anchor or pTRP cell that holds the control of the configuration.

In an example, the PHR report may be restructured. The TRPs may be numbered using indexes, part of the PHR report, and the (e.g., specific) indications related to the polarization cases (e.g., sharing/non-sharing power status, specific polarization type 1 or 2, or a measurement mode 1 or 2) may be directly indicated or inferred from the configured report format. In an example, the PHR report may be carried out into an RRC message capable of accommodating the (e.g., whole) structure of an enhanced PHR for mDCI STxMP that would use an extra octet that may include the specificity of polarization cases (e.g., power sharing/non-power sharing status or vice versa, specific polarization type 1 or 2, or a measurement mode 1 or 2).

The PHR report may include at least one or a combination of the following: Pcmax for a UL beam on their specific polarization (Pcmax_Hz and Pcmax_Vt); the status of the sharing/non-sharing power of the current serving panels/antenna ports; the power headroom for an individual beam and polarization; an indication of the active polarization which may be Hz (horizontal) or Vt (vertical); and/or there may be a TRP indication (per TRP) to identify the TRP associated with the active polarization indication, or the order of entries of the active UL polarizations indications in the PHR may indicate the association with a specific TRP.

Systems, methods, and instrumentalities are configured for power headroom triggering and reporting for uplink polarization-based operation. A wireless transmit/receive unit (WTRU) may send a power capability. The power capability may be associated with one or more antenna ports or antenna port groups. The WTRU may determine that a condition is satisfied. The condition may include one or more of the power capability of the WTRU changing or a serving panel of the WTRU changing. The WTRU may send a power headroom report (PHR) based the condition being satisfied. The PHR may indicate a maximum power associated with a first polarization type and a maximum power associated with a second polarization type.

The first polarization type may include a first orientation polarization type, and the second polarization type may include a second orientation polarization type. The condition may include one or more of the following: the WTRU is configured for multi-Transmission Reception Point (mTRP) operation, a difference between a measured horizontal Reference Signal Received Power (H-RSRP) and a measured vertical Reference Signal Received Power (V-RSRP) exceeds a threshold, an uplink (UL) polarization the WTRU is using for a transmission reference point (TRP) changes, or a maximum power for an active polarization type changes by more than a threshold.

The PHR may include one or more of the following: a power capability of the WTRU or an indication of an active UL polarization. The indication of the active UL polarization may be associated with a TRP. The indication may identify the TRP associated with the UL polarization.

Systems, methods, and instrumentalities are configured for Power Headroom Report (PHR) triggering and reporting for Uplink (UL) polarization-based operation. A wireless transmit/receive unit (WTRU) may send a power capability associated with one or more antenna ports or antenna port groups.

The WTRU may send a power headroom report (PHR) when conditions are met. The conditions may include the WTRU being configured for multi-Transmission Reception Point (mTRP) operation, changes in the WTRU's power capability or serving panel, a significant difference between measured horizontal and vertical Reference Signal Received Power (H-RSRP and V-RSRP), changes in the WTRU's UL polarization for a TRP, and/or a substantial change in maximum power for the active polarization type. The PHR may include information on horizontal polarization maximum power (Pcmax-Hz), vertical polarization maximum power (Pcmax-Vt), and/or an indication of the active UL polarization.

The WTRU may send the power capability in response to a network request. The threshold for the difference between H-RSRP and V-RSRP may be received from a network or configured by the WTRU.

Measurement Reference Signals (RS) used for calculating H-RSRP and V-RSRP may be a Synchronization Signal Block (SSB), a Channel State Information Reference Signal (CSI-RS), or a pathloss RS. Additionally, the order of active UL polarization indications in the PHR may determine or indicate the associated TRP.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-12. (canceled)

13. A wireless transmit/receive unit (WTRU) comprising a processor:
the processor configured to:
send a power capability of the WTRU, wherein the power capability is associated with one or more antenna ports or antenna port groups;
determine that a condition is satisfied, wherein the condition comprises one or more of the power capability changing or a serving panel of the WTRU changing; and
send a power headroom report (PHR) based the condition being satisfied, wherein the PHR indicates a maximum power associated with a first polarization type and a maximum power associated with a second polarization type.

14. The WTRU of claim 13, wherein the first polarization type comprises a first orientation polarization type and the second polarization type comprises a second orientation polarization type.

15. The WTRU of claim 13, wherein the condition further comprises one or more of:
the WTRU is configured for multi-Transmission Reception Point (mTRP) operation, a difference between a measured horizontal Reference Signal Received Power (H-RSRP) and a measured vertical Reference Signal Received Power (V-RSRP) exceeds a threshold, an uplink (UL) polarization the WTRU is using for a transmission reference point (TRP) changes, or a maximum power for an active polarization type changes by more than a threshold.

16. The WTRU of claim 13, wherein the PHR further comprises one or more of the following: the power capability of the WTRU or an indication of an active UL polarization.

17. The WTRU of claim 16, wherein the indication of the active UL polarization is associated with a TRP.

18. The WTRU of claim 17, wherein the indication identifies the TRP associated with the active UL polarization.

19. A method for a wireless transmit/receive unit (WTRU), the method comprising:
sending a power capability of the WTRU, wherein the power capability is associated with one or more antenna ports or antenna port groups;
determining that a condition is satisfied, wherein the condition comprises one or more of the power capability changing or a serving panel of the WTRU changing; and
sending a power headroom report (PHR) based the condition being satisfied, wherein the PHR indicates a maximum power associated with a first polarization type and a maximum power associated with a second polarization type.

20. The method of claim 19, wherein the first polarization type comprises a first orientation polarization type and the second polarization type comprises a second orientation polarization type.

21. The method of claim 19, wherein the condition further comprises one or more of:
the WTRU is configured for multi-Transmission Reception Point (mTRP) operation, a difference between a measured horizontal Reference Signal Received Power (H-RSRP) and a measured vertical Reference Signal Received Power (V-RSRP) exceeds a threshold, an uplink (UL) polarization the WTRU is using for a transmission reference point (TRP) changes, or a maximum power for an active polarization type changes by more than a threshold.

22. The method of claim 19, wherein the PHR further comprises one or more of the following:
the power capability of the WTRU or an indication of an active UL polarization.

23. The method of claim 22, wherein the indication of the active UL polarization is associated with a TRP.

24. The method of claim 23, wherein the indication identifies the TRP associated with the active UL polarization.
